(19) United States
(12) Patent Application Publication
(10) Pub. No.: US 2002/0032969 A1
(43) Pub. Date: Mar. 21, 2002

(54) Scribing apparatus and method

(76) Inventor: Tobias M. Cardew, Salisbury (GB)

Correspondence Address: DAVID KIEWIT, 5901 THIRD ST SOUTH, ST PETERSBURG, FL, 33705, US

(21) Appl. No.: 09/912,866

(22) Filed: Jul. 25, 2001

Related U.S. Application Data
(60) Provisional application No. 60/221,111, filed on Jul. 27, 2000.

(51) Int. Cl. B43L 13/02

(52) U.S. Cl. 33/42; 33/44

(57) ABSTRACT

A marking apparatus provides a method of marking a line on a surface of a workpiece at a selected distance from a datum edge of the surface. To practice this method a scribe retaining apparatus is attached to a ruling blade of a geometrical instrument so that it can slide along an axis of the ruling blade. A stock of the geometrical instrument is then brought into abutting contact with the datum edge and held against it at an angle selected so that a first, flat, portion of a bottom of the scribe retaining apparatus abuts the surface of the workpiece. In this orientation a working tip of a retained scribe is adjacent to, but out of contact with, the surface of the workpiece. One then slides the scribe retaining apparatus axially along the ruling blade until the working tip of the scribe is at the selected distance from the datum edge, and locks the scribe retaining apparatus to the ruling blade. The stock of the geometrical instrument is then rotated about the axis of the ruling blade to bring a second portion of the bottom of the scribe retaining apparatus into contact with the surface of the workpiece. In this position the working tip of the scribe is in operative marking contact with the workpiece. One then slides the stock of the geometrical instrument along the datum edge to mark the line at the selected distance.

### CROSS REFERENCE TO RELATED APPLICATIONS

This application claims the priority of U.S. Provisional Application for No. 60/221,111, filed Jul. 27, 2000

### BACKGROUND OF THE INVENTION

1. Field of the Invention

The invention relates to apparatus and method for marking a line a selected distance from an edge of a workpiece.

2. Background Information

It is usual in woodworking to mark out cut lines by using a marking gauge. This tool, which has a long history, has two parts—a wooden collar and a wooden rod. The rod passes through a hole in the collar and terminates in a sharp pin placed normal to the axis of the rod. The rod, which has a cross section designed to resist rotation, may slide in the hole and be locked in any axial position by a locking screw. When marking lines using this tool, the pin is displaced a desired amount from the collar and locked in position and a line is scribed down the wood by holding the collar in contact with a datum edge and drawing the gauge down the work. This tool can be difficult to use, and is particularly prone to scribe an untrue line if the wood is heavily grained or if the pin is located distal from the collar. The collar, when held to the datum edge, must resist changes in scribing force on the pin. As the ratio of pin displacement from the collar to collar width increases to as much as 3:1 scribing a line in a steady and accurate manner becomes more difficult and provides a source of dimensional error.

Descriptions of marking arrangements that are newer than the traditional marking gauge may be found in the patent literature and include:

U.S. Pat. No. 5,430, 947, wherein Courtney discloses a geometrical instrument for use with a straight edge to mark positions on a flat surface. Courtney's instrument has a receiver slot on its rear side so that the instrument can be slid along the straightedge, and a holder to position a writing implement above the receiver slot so that the writing implement marks the surface. Courtney does not provide a writing implement retaining apparatus arranged to hold the writing implement out of contact with the flat surface until the user rotates the straightedge about its axis to bring the writing implement into operative contact with the surface.

U.S. Pat. No. 5,309,642, wherein McGinnis discloses a mat marking and cutting apparatus having a flat-bottomed body arranged to slide along a ruling blade. McGinnis teaches the use of a knife that is pivotally mounted on the slidable body.

U.S. Pat. No. 4,158,977, wherein Logan teaches a mat cutter similar to that of McGinnis in that it, too, comprises a flat-bottomed arranged to slide along a ruling blade and incorporates a knife that is pivotally mounted on the slidable body. Logan also shows a locking screw for holding the slidable body in a fixed position along the ruling blade.

U.S. Pat. No. 4,979,304, and U.S. Pat. No. 2,835,037, wherein Sprague, and Middent, respectively, disclose cutting devices movable along a tongue or ruling blade portion of a T-square shaped guide.

### BRIEF SUMMARY OF THE INVENTION

A preferred embodiment of the invention comprises a scribe retaining apparatus designed to fit on the ruling blade of a try square, T-square, or other such instrument and to be secured to that blade with a locking device. An integrally mounted block may be bored to take a pencil or alternatively to retain a scribing point similar in form and action to that of the historic marking gauge. Preferred clamp units are made in both a left and right handed form for use by left and right handed users and also for use in pairs when more than one line is to be scribed. Various embodiments of the invention may also be locked on to a steel rule and used in a compass or trammel for the laying out of arcs or curved lines.

A preferred embodiment of the invention comprises a retaining apparatus for holding a scribe used with a ruling blade for scribing a line on a workpiece. This retaining apparatus, in turn, comprises a body having a top, a bottom, a back, a front, a right side and a left side and a receiver slot extending across the body from the right side to the left side. This receiver slot is adapted to receive the ruling blade in an arrangement allowing the body to selectively slide along the ruling blade. The retaining apparatus also comprises a locking device adapted to lock the ruling blade to the body and a scribe clamp adjacent the front of the body. This scribe clamp extends upwards from the top of the body and is adapted to releasably retain the scribe so that a tip of the scribe extends outwardly of the front of the body. The bottom surface of the body comprises a rearward surface portion adjacent the rear of the body, and a forward surface portion distal from the back of the body. The forward and rearward surface portions meet along a separation line extending across the body from the right side to the left side. The rearward surface portion of the bottom comprises a flat surface parallel to the receiver slot, and the forward portion comprises a flat surface slanting upwards from the separation line towards the front of the body

The invention provides a preferred method of marking a line on a surface of a workpiece at a selected distance from a datum edge of the surface. To practice this method one first attaches a scribe retaining apparatus to a ruling blade of a geometrical instrument so that the scribe retaining apparatus can slide along an axis of the ruling blade. A stock of the geometrical instrument is then brought into abutting contact with the datum edge and held against the datum edge at an angle selected so that a first, flat, portion of a bottom of the scribe retaining apparatus abuts the surface of the workpiece. In this orientation a working tip of a scribe retained in the scribe retaining apparatus is held adjacent to, but out of contact with, the surface of the workpiece. One then slides the scribe retaining apparatus axially along the ruling blade until the working tip of the scribe is at the selected distance from the datum edge, and locks the scribe retaining apparatus to the ruling blade. The stock of the geometrical instrument is then rotated about the axis of the ruling blade to bring a second portion of the bottom of the scribe retaining apparatus into contact with the surface of the workpiece. In this position the working tip of the scribe is in operative marking contact with the workpiece. One then slides the stock of the geometrical instrument along the datum edge to mark the line at the selected distance.

Another feature of the invention is that it provides a marking apparatus for guiding a scribe along a straight line at a selected distance from a datum edge. This apparatus comprises a combination of a geometrical instrument and a scribe retaining apparatus. The geometrical instrument in this combination comprises an elongated ruling blade and a stock that has a guide face perpendicular to the ruling blade. Both a try square and a T square are examples of suitable geometrical instruments. The scribe retaining apparatus is attached to the ruling blade for sliding motion therealong and comprises means to lock the scribe retaining apparatus to the ruling blade at a position selected so that a working tip of the scribe is at the selected distance from the datum edge. The scribe retaining apparatus further comprises two flat bottom surface portions meeting along a separation line that is perpendicular to the guide face of the try square when the scribe retaining apparatus is attached to the ruling blade. A first of these flat bottom portions is disposed parallel to the ruling blade and the second of the two flat bottom portions slanted with respect to the ruling blade.

One objective of the present invention is to replace the marking gauge with a smaller device that adapts a standard try square to perform the function of the marking gauge, but with greater efficiency.

Another object of the invention is to provide apparatus for scribing a steadier line at a greater distance from a datum edge than can be done with the prior art marking gauge. Various embodiments of the invention allow one to scribe a line with a pencil or with a scribing point or to employ a disposable blade either for marking a workpiece or for cutting thin stock, such as a mat.

### BRIEF DESCRIPTION OF THE SEVERAL VIEWS OF THE DRAWING

FIG. 1 is a perspective elevational view of a scribing apparatus of the invention being used to mark a line on a workpiece.

FIG. 2 is a plan view of a right-handed and a left-handed embodiment of a scribe holder of the invention being used to mark respective lines on a workpiece.

FIG. 3 is a side view of a scribe holder of the invention resting on a workpiece in a non-marking orientation.

FIG. 4 is a side view of the scribe holder of FIG. 4 rotated about an axis of a ruling blade so as to bring a marker into a marking orientation.

FIG. 5 is a plan view of a bottom portion of a body of a scribe holder of the invention.

### DETAILED DESCRIPTION OF THE INVENTION

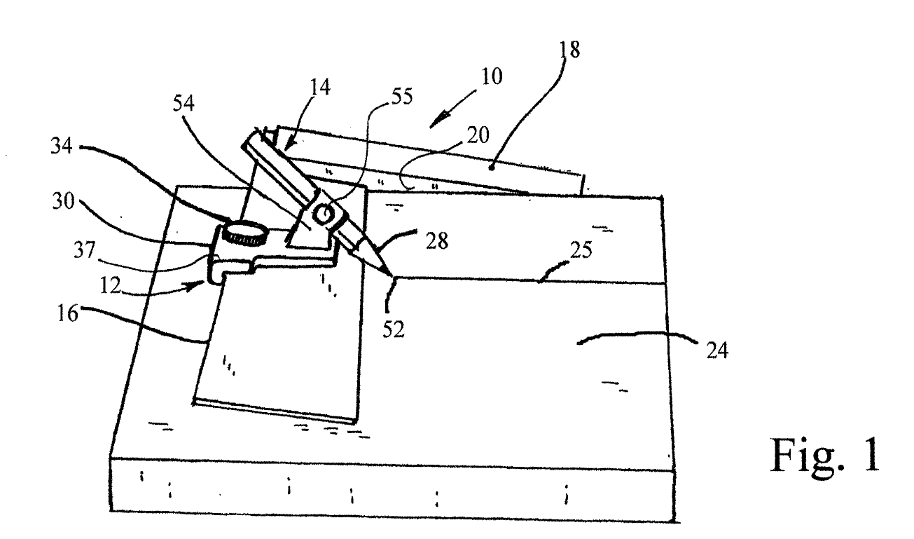

Turning now to FIG. 1, one finds a scribing apparatus 10 comprising, in combination, a scribe holder 12 of the invention and a geometrical instrument 14, which may be a conventional try square or T square, comprising a ruling blade 16 attached to a stock 18. As is conventional in try squares, a ruling blade 16 extends away from the stock 18 in a direction perpendicular to a flat reference face 20 of the stock 18. In the depiction of FIG. 1, the ruling blade 16 is rotated about its axis 22 to tilt it with respect to a surface 24 of a workpiece 26 so that a scribe 28 is brought into operative contact with the surface 24 in order to mark a line 25 thereon.

Although the scribe retaining apparatus 12 of FIG. 1 is depicted retaining a pencil, it will be clear that many other sorts of scribes can be retained in the same apparatus. Other scribes that can be retained in the apparatus of the invention include, but are not limited to, markers adapted to mark the surface with ink, pointed metal tools usable to scratch a scribe line, and knife blades usable for either marking a scribe line or making a cut into or through the workpiece. Moreover, although the detailed description herein presented addresses arrangements for scribing a line into a workpiece at a selected distance from a straight planar datum edge 36 of the workpiece itself, it will be recognized that the same apparatus and methods are applicable to other situations. For example, the apparatus of the invention could be used for marking or cutting a sheet or mat held to a working surface of a table, in which cases the datum edge is provided by the table, rather than by the material being cut or marked.

A preferred scribe holder 12 comprises a base portion, or body, 30 having a receiving slot 32 extending therethrough. The slot 32 has a size and thickness selected to accord with that of a ruling blade 16. Thus, when viewed from the side, the scribe holder base 30 has a U-shaped profile which allows it to be slid along a ruling blade 16 to a desired position. In the preferred embodiment a locking device is employed to lock the body 30 of the scribe holder 12 to the ruling blade 16 when the scribe 28 is at a desired distance from a datum edge 36 of the workpiece 26. In the depicted embodiments the locking device 34 comprises a locking screw turned into a threaded hole extending from a top 37 of the body 30 to the receiving slot 32. It will be understood by those skilled in the art that many other locking devices, such as a spring clip (not shown) could be used to retain the scribe holder 12 in a desired position along the ruling blade.

The receiving slot 32 extends entirely across the body 30 from a left side 38 to a right side 40 thereof. The slot 32 is preferably parallel to a rearward portion 42 of a bottom surface 44 of the body 30. The rearward portion 42 is adjacent the rear side 46 of the body 30 and is separated by a separation line 48 from a forward portion 50 of the bottom 44, which is preferably slanted with respect to the slot 32 by a relieving angle α, which preferably has a magnitude of about seven degrees of arc. This arrangement, in which the separation line is parallel to an axis of the ruling blade, allows the body 30 to rest on the workpiece 26 with the rearward portion 42 of the body abutting the working surface 24 and with a scribe point 52 adjacent, but not contacting, the working surface 24. If the ruling blade 16 is rotated about its axis 22, the rearward portion is rotated out of contact and the forward portion 50 of the bottom 44 of the slidable body 30 is rotated into contact with the working surface 24. In this rotated state the scribe point 52 is in operative contact with the working surface.

In a preferred embodiment the body 30 of the apparatus comprises an upper part 31 and a lower part 33 that are held together by suitable means, such as screws 37. In this embodiment the upper part 31 may have a flat bottom, and the lower part 33 may be shaped to receive the blade 16. In the preferred embodiment depicted in FIG. 5, a pair of small teeth 58 extend forwardly from the rearward portion 42 of the lower part 33 of the body 30. The teeth 58 are separated by a relieved region 60 that does not contact an inserted blade. This arrangement provides a precise two-point support at the back edge of the receiver slot for the back edge of the blade 16 and serves to reduce possible angular setting errors between the scriber 12 and the blade 16 when the scriber body 30 is slid along and then clamped to the blade 16.

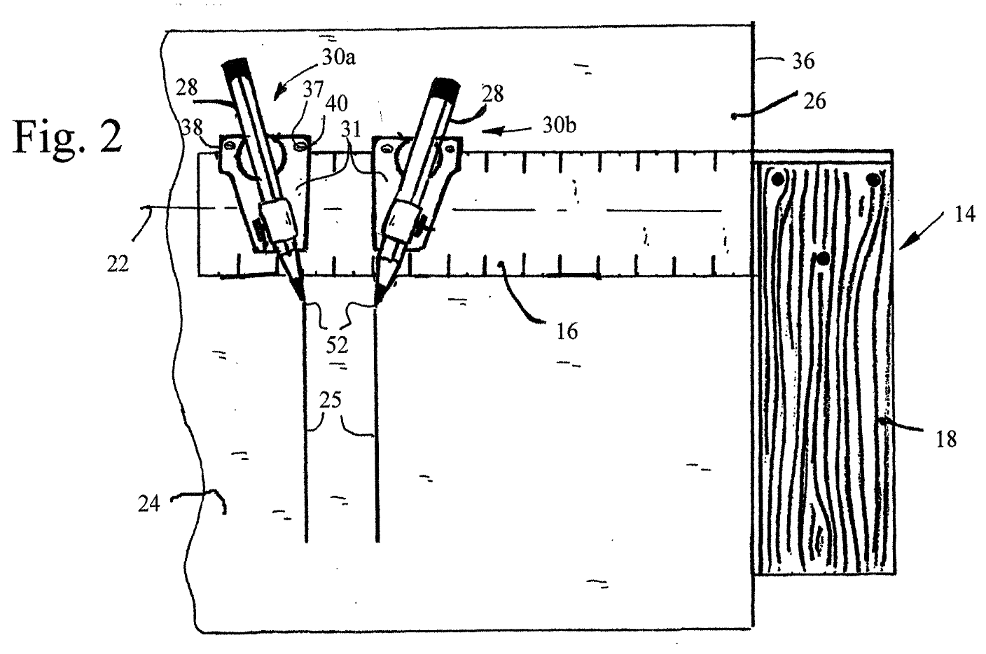

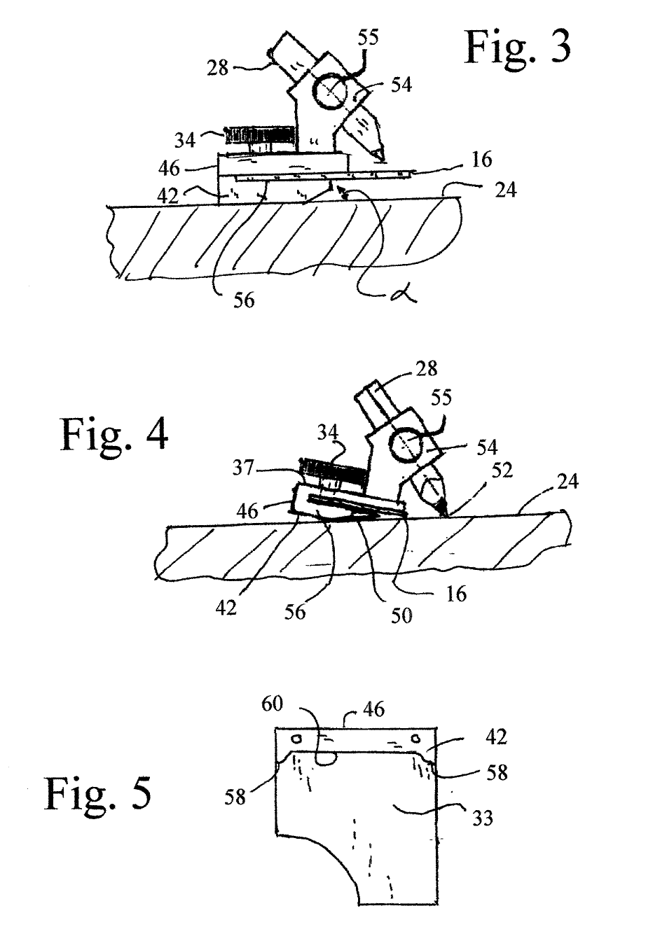

A scribe clamp 54 preferably extends upwardly from body 30 and is used to hold a scribe 28 in a fixed angular orientation with respect to the body 30 so as to allow scribe 28 to project forward of the body 30 and of the ruling blade 16. The scribe clamp 54 preferably comprises a clamping screw 55 that may be loosened to allow a user to slide a scribe 28 to and fro so that the tip 52 of the scribe is in operative contact with the working surface when the body 30 is rotated so that the forward portion 50 of the bottom 44 of the body 30 is in abutting contact with the working surface 24. In a preferred embodiment the clamp 54 may be integrally formed with the base portion 30 and may comprise a hole bored at a compound angle in both the horizontal and vertical planes so that the scribe tip 52 contacts the working surface 24 beyond the limits of the body (i.e., to either the right or to the left side of the body) in order that the user can align the scribe tip with fiduciary marks disposed on the ruling blade. Moreover, in order to satisfy both right-handed and left-handed users, one may provide both right handed 30a and left-handed 30b bodies, as depicted in FIG. 2. In addition, the provision of both right- and left-handed versions allow the user to simultaneously scribe two parallel lines 25 very close to each other and thus to delineate very thin sections.

In a preferred apparatus 10, the scribe holder 12 is used with a geometrical instrument 14 having a stock 18 that is at least twice as thick as is the bottom wall 56 of the retaining slot. When this combination is used, the ruling blade can be held parallel to the working surface 24 while the reference face 20 of the stock is in contact with the datum edge 36. If a thinner stock 18 is employed (e.g., if one were to use a try square stamped from a single sheet of metal so that the blade and stock were of identical thickness), the apparatus is a bit less convenient to use in that the user must rotate the ruling blade part of the way towards the marking position in order to allow the reference face 20 to abut the datum edge 36.

It may be noted that the scribe retainer 12 of the invention may be used in conjunction with a steel rule or any bar of suitable cross section as a compass or trammel for striking circles or arcs on a working surface. For example, two retainers 12 may be spaced apart along a bar or blade. When in use pressure is applied to top of one of the scribe retainers so as to hold it in a fixed position while the other of the scribe retainers is moved across the surface to mark out an arcs or a circle.

Although the present invention has been described with respect to several preferred embodiments, many modifications and alterations can be made without departing from the invention. Accordingly, it is intended that all such modifications and alterations be considered as within the spirit and scope of the invention as defined in the attached claims.

1) A retaining apparatus for holding a scribe that is used with a ruling blade for scribing a line on a workpiece, the retaining apparatus comprising:
a body having a top, a bottom, a back, a front, a right side and a left side, the body comprising a receiver slot extending across the body from the right side to the left side thereof, the receiver slot adapted to receive the ruling blade therein;
a locking device adapted to lock the ruling blade to the body when the ruling blade is disposed therein;
a scribe clamp adjacent the front of the body, the scribe clamp extending upwards from the top of the body, the scribe clamp adapted to releasably retain the scribe so that a tip of the scribe extends outwardly of the front of the body;
wherein the bottom surface of the body comprises a rearward surface portion adjacent the rear of the body, and a forward surface portion distal from the back of the body, the forward and rearward surface portions meeting along a separation line extending across the body from the right side to the left side, the rearward surface portion of the bottom comprising a flat surface parallel to the receiver slot, the forward portion comprising a flat surface slanting upwards from the separation line towards the front of the body.

2) The apparatus of claim 1 wherein the locking device comprises a screw.

3) The apparatus of claim 1 wherein the scribe comprises one of a pencil, a pointed metal tool and a knife blade.

4) The apparatus of claim 1 wherein the scribe clamp comprises a hole arranged so that the scribe tip contacts the working surface beyond the limits of the body.

5) The apparatus of claim 1 wherein the body comprises two teeth extending forwardly of a back edge of the receiver slot, the two teeth separated by a relieved region.

6) A method of marking a line on a surface of a workpiece at a selected distance from a datum edge of the workpiece, the method comprising the steps of:
attaching a scribe retaining apparatus for sliding motion along a ruling blade of a geometrical instrument that comprises the ruling blade and a stock having a guide surface adapted to be brought into abutting contact with the datum edge;
holding the stock of the geometrical instrument against the datum edge at an angle selected so that a first, flat, portion of a bottom of the scribe retaining apparatus abuts the surface of the workpiece, whereby a working tip of a scribe retained in the scribe retaining apparatus is held adjacent to, but out of contact with, the surface of the workpiece;
sliding the scribe retaining apparatus axially along the ruling blade until the working tip of the scribe is at the selected distance from the datum edge of the workpiece;
locking the scribe retaining apparatus to the ruling blade;
rotating the stock of the geometrical instrument about an axis of the blade to bring a second portion of the bottom of the scribe retaining apparatus into contact with the surface of the workpiece, and to thereby bring the working tip of the scribe into operative marking contact with the workpiece; and
sliding the stock of the geometrical instrument along the datum edge to mark the line at the selected distance therefrom.

7) The method of claim 6 wherein the first portion of the bottom of the body is distal from the scribe tip and the second portion is proximal thereto.

8) The method of claim 6 wherein the geometrical instrument is a try square.

9) The method of claim 6 wherein the step of locking the scribe retaining apparatus to the ruling blade comprises tightening a locking screw.

10) An apparatus for guiding a scribe along a straight line at a selected distance from a datum edge of a workpiece, the apparatus comprising, in combination:
a geometrical instrument comprising a ruling blade and a stock, the stock having a guide face perpendicular to the ruling blade; and
a scribe retaining apparatus attached to the ruling blade for motion therealong, the scribe retaining apparatus comprising a locking device for locking the scribe retaining apparatus to the ruling blade at a position selected so that a working tip of the scribe is at the selected distance from the datum edge;
wherein the scribe retaining apparatus further comprises two flat bottom surface portions meeting along a separation line that is perpendicular to the guide face of the geometrical instrument when the scribe retaining apparatus is attached to the ruling blade, a first of the flat bottom portions disposed parallel to the ruling blade and the second of the two flat bottom portions slanted with respect to the ruling blade.

11) The apparatus of claim 10 wherein the geometrical instrument is a try square.

12) The apparatus of claim 10 wherein the locking device comprises a locking screw.

13) The apparatus of claim 10 wherein the separation line is parallel to an axis of the ruling blade.

14) The apparatus of claim 10 wherein the scribe retaining apparatus comprises a receiving slot for receiving the ruling blade, a wall of the receiving slot extending from the receiving slot to the first flat bottom portion having a thickness no greater than one half a thickness of the guide face portion of the stock.
